(19) United States
(12) Patent Application Publication
(10) Pub. No.: US 2010/0282889 A1
(43) Pub. Date: Nov. 11, 2010

(54) SEAT BELT PRETENSIONER FOR A MOTOR VEHICLE

(76) Inventors: Erik Hjerpe, Torslanda (SE); Dan Bråse, Vargarda (SE)

Correspondence Address: HARNESS, DICKEY & PIERCE, P.L.C., P.O. BOX 828, BLOOMFIELD HILLS, MI, 48303, US

(21) Appl. No.: 12/811,310

(22) PCT Filed: Jan. 16, 2008
(86) PCT No.: PCT/SE08/50049

§ 371 Date: Jun. 30, 2010

(51) Int. Cl. B60R 22/46

(52) U.S. Cl. 242/374

(57) ABSTRACT

A pretensioner arrangement for a vehicle safety belt includes a safety belt retractor (12,14) comprising a retractor reel (14) mounted for rotation in a retractor frame (12) and a pretensioner actuator (16) including a first rotary output member (18) connected with the retractor reel by way of a first dutch arrangement, and a second rotary output member (28) connected with the retractor reel by way of a second dutch arrangement, the clutch arrangements being such that the output members (18,28) can apply successive displacements to the retractor reel. The first rotary output member (18) is coupled with a first rotary piston (44) mounted within a working cylinder (42) having a first input (50) for pressurized gas to drive the rotary piston (44) and first output member (18), and the second rotary output member (28) is coupled with a second rotary piston (46) mounted within the same working cylinder (42) which has a second input (51) for gas produced by a pyrotechnic gas generator when the latter is fired. A first, pre-crash sensor may trigger opening of a valve connecting the first input (50) with a source of pressurized gas, whilst the pyrotechnic gas generator may be triggered by forces substantially greater than those triggering the last noted valve, such as forces arising in an actual impact of the vehicle in which the arrangement is fitted.

This invention relates to a seat belt arrangement for a motor vehicle and to a pretensioner for such a seat belt arrangement.

In a conventional three-point motor vehicle safety belt arrangement, a length of strong webbing is secured at one end to the vehicle body, passes through an aperture in a tang adapted to cooperate releasably with a buckle also connected with the vehicle body, and passes through, for example, a guide mounted on a “B” pillar of the vehicle adjacent the associated vehicle seat, to a so-called retractor, comprising a reel or bobbin which is rotatable in a retractor frame secured to the vehicle. The safety belt is secured at its other end to this reel or bobbin which is spring-biased in a sense to cause it normally to wind the webbing onto the reel to take up any slack in the webbing, and can normally be drawn from the reel simply by pulling the belt. However, in an accident situation, a blocking mechanism acts to block rotation of the reel to prevent drawing of the belt from the reel and thus to restrain movement of the person wearing the belt. The blocking mechanism may be inertially or centrifugally operated or operated by gravitational forces in the event of the vehicle tilting excessively, for example in a rollover situation.

It is known to provide a vehicle safety belt arrangement of the above character with a pretensioner. A pretensioner operates at an early stage in a crash situation to tighten the respective seat belt to prevent the occupant from jerking forward in the crash. Thus, in the event of a crash, such a pretensioner will tighten the belt almost instantaneously, to reduce the motion of the occupant in a violent crash.

Pretensioners have been developed which are activated by so-called crash sensors sensing, for example, abnormal deceleration indicating that a crash may be imminent. However, a crash may not always actually occur in circumstances where such a pre-crash sensor is triggered and it is then desirable for the action of the pretensioner to be reversible, for example where the action of the pretensioner is to cause the seat belt reel to wind in more of the webbing to tighten the belt around the occupant of the respective seat, it is desirable for the action of the pretensioner to be reversible, if no crash actually occurs, to allow the reel to unwind again sufficiently to allow the occupant to release the belt. At the same time, it is desirable, should the respective vehicle actually suffer an impact with an obstacle, that the pretensioner should have acted at an early stage to pull the occupant firmly into place against the occupant's seat before the instant of impact.

It is an object of the present invention to provide an improved seat belt arrangement meeting these desiderata.

According to the present invention, there is provided a pretensioner arrangement for a vehicle safety belt, including a safety belt retractor comprising a retractor reel mounted for rotation in a retractor frame and a pretensioner actuator assembly including a first pretensioner having a first output member having a normal position, the first output member being connected with the retractor reel by way of a first clutch arrangement, the pretensioner actuator assembly including a second pretensioner having a second output member having a normal position, the second output member being connected with the retractor reel by way of a second clutch arrangement, said clutch arrangements being such that the first output member can, via its clutch arrangement, rotate the retractor reel by up to a predetermined extent without displacement of the second output member and the clutch arrangement for the second output member can thereafter, if the second output member is energized, engage the retractor reel, via the second clutch arrangement, to apply torque to the retractor reel, from the beginning of displacement of the second output member from its normal position.

Preferably the first output member is a rotary output member coupled with a first rotary piston mounted within a working cylinder having an input for gas under pressure to drive the rotary piston, and hence the respective output member, and the second output member is a rotary output member coupled with a second rotary piston mounted within a working cylinder having an input for gas under pressure to drive the second rotary piston, and hence the second output member,

Preferably in this case, the pretensioner actuator assembly includes an inlet associated with the first output member connected, via valve means, with a reservoir of pressurised gas and a further inlet associated with the second output member and connected with a pyrotechnic gas generator.

In preferred embodiments of the invention, the first and second rotary pistons share a common working cylinder, and each takes the form of a vane extending generally radially in said cylinder and in substantial sealing relationship with the peripheral surface of said cylinder; in sealing relationship with opposite ends of the cylinder and in sealing relationship with respect to, or integral with, a central structure in said cylinder, the pretensioner motor further including a radially extending fixed stop or wall in said cylinder extending from the peripheral wall thereof to said central structure and in substantial sealing relationship with the peripheral surface of said cylinder; in sealing relationship with opposite ends of the cylinder and in sealing relationship with respect to said central structure.

In embodiments of the invention the first pretensioner and the second pretensioner act in series, so that tensioning movement imparted to a seat belt by the second pretensioner will be added to the tensioning movement imparted to the seat belt by the first pretensioner, and the first pretensioner is driven by means, such as compressed air, such that the first pretensioner is capable of exerting a relatively low tension on the seat belt, but of drawing in a relatively large amount of slack in the seat belt, whilst the second pretensioner is driven by means, such as a pyrotechnic charge, by which it is capable of exerting a relatively high tension on the seat belt.

The first and second pretensioners may be arranged to be triggered by respective sensors, with different thresholds, for example with the sensor for the first pretensioner being, for example, a pre-crash sensor triggered by a sensed parameter indicative of the likelihood of a crash and with the sensor for the second pretensioner being triggered by a parameter at a level indicative of an early stage of an actual crash.

Embodiments of the invention are described below with reference to the accompanying drawings, in which:

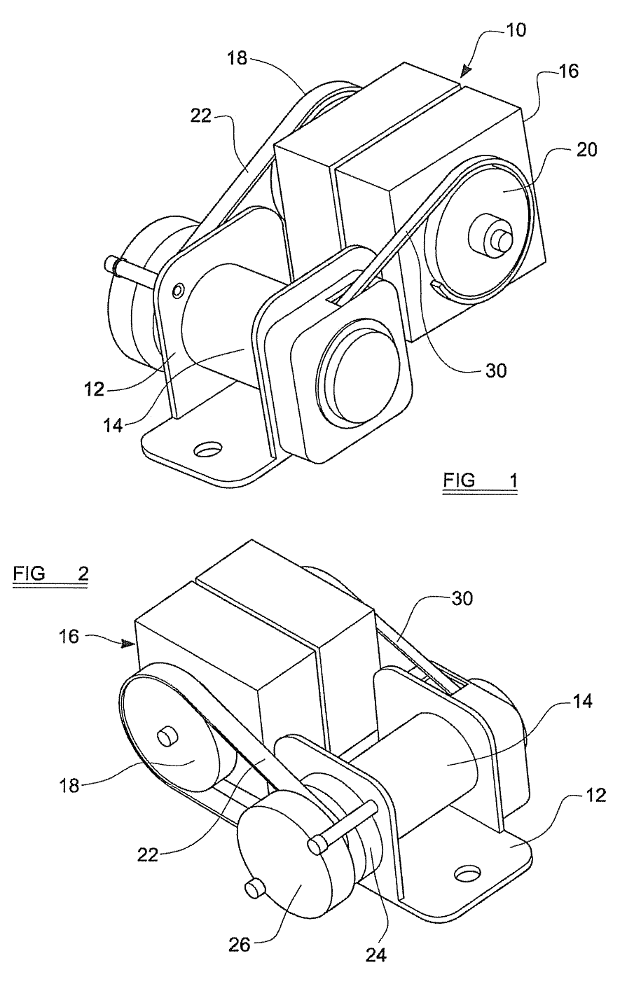

FIG. 1 is a schematic perspective view showing, from above and one side, an assembly forming part of a motor vehicle safety belt arrangement embodying the invention,

FIG. 2 is a schematic perspective view of the assembly of FIG. 1, from above and the opposite side,

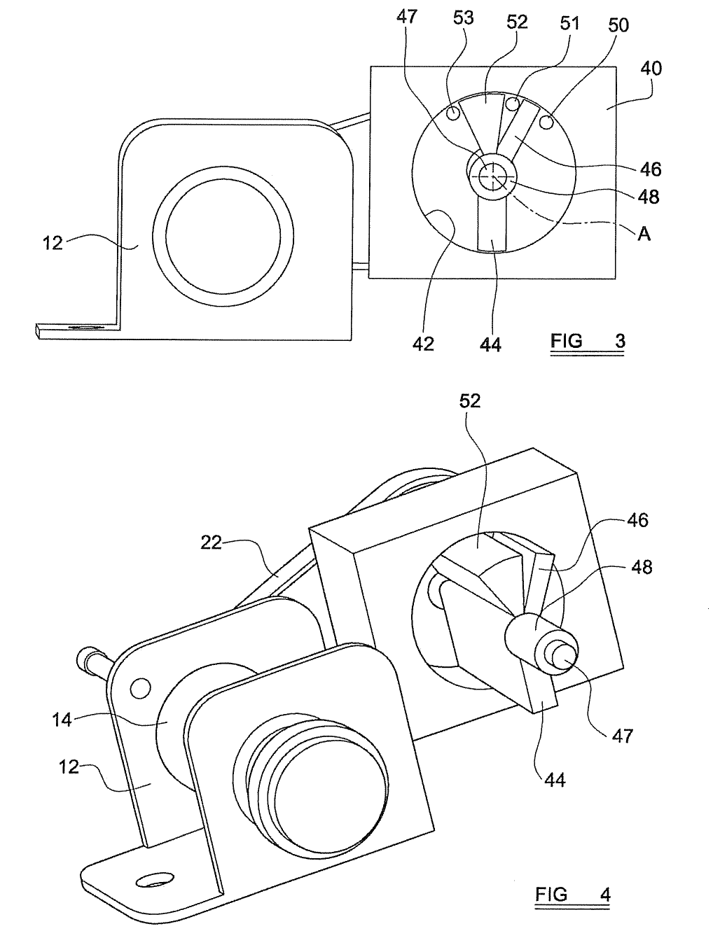

FIG. 3 is a schematic side view of part of the assembly of FIG. 1, with the remainder omitted for purposes of illustration,

FIG. 4 is a schematic perspective view of the part of the assembly shown in FIG. 3,

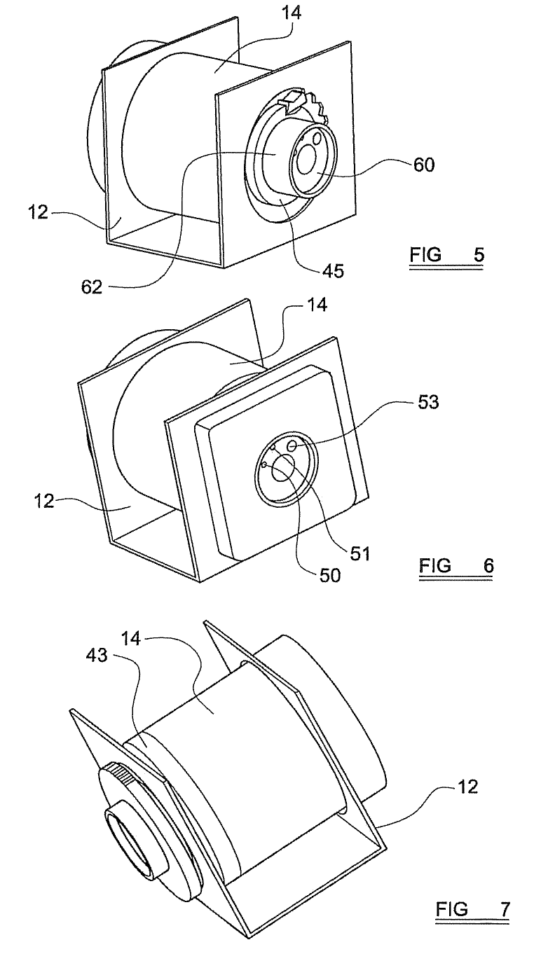

FIG. 5 is a schematic perspective view showing, from above and one side, an assembly forming part of another form of motor vehicle safety belt arrangement embodying the invention, and with parts omitted for purposes of illustration,

FIG. 6 is a schematic perspective view corresponding to FIG. 5 but showing a housing in place,

FIG. 7 is a schematic perspective view of the assembly of FIGS. 5 and 6 from another viewpoint,

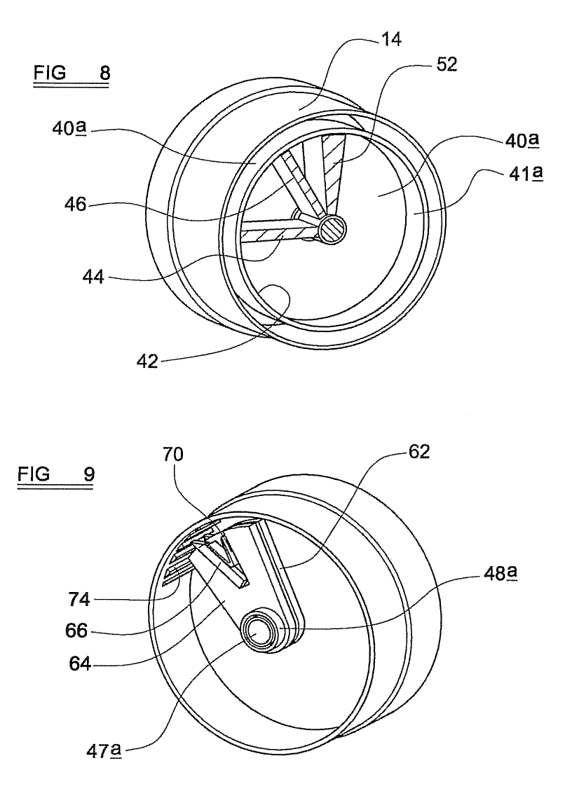

FIG. 8 is a fragmentary perspective view showing part of the assembly of FIGS. 5 to 7,

FIG. 9 is a fragmentary perspective view showing another part of the assembly of FIGS. 5 to 8,

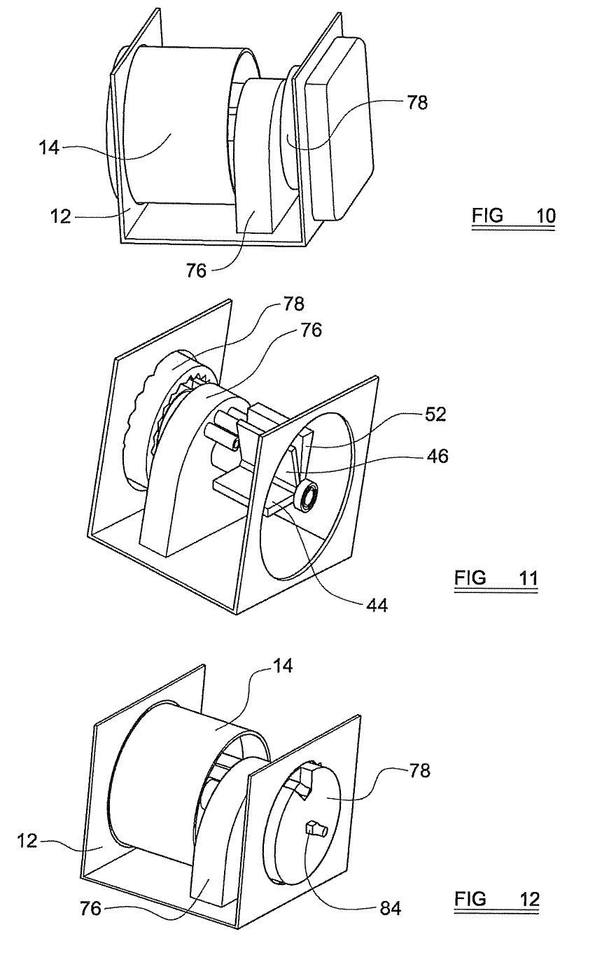

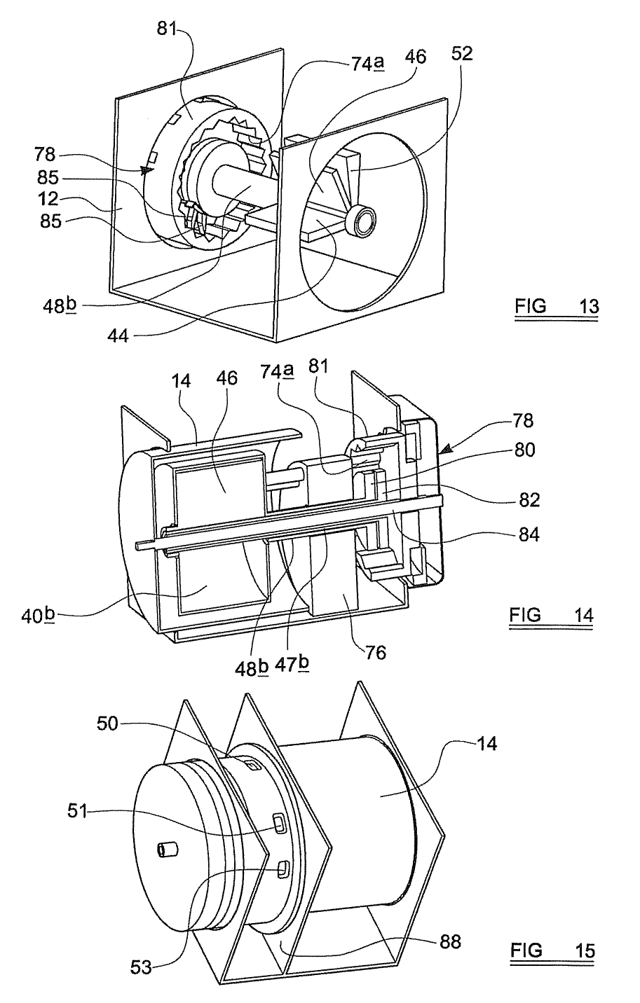

FIGS. 10, 11, 12 and 13 are schematic perspective views each showing an assembly forming part of another yet another form of motor vehicle safety belt arrangement embodying the invention, again with parts omitted for purposes of illustration,

FIG. 14 is a schematic view partly in section along the retractor reel axis and partly in perspective of the assembly of FIGS. 10 to 13,

FIGS. 15 and 17 are schematic perspective views showing, from respective sides, part of an assembly forming part of another yet another form of motor vehicle safety belt arrangement embodying the invention,

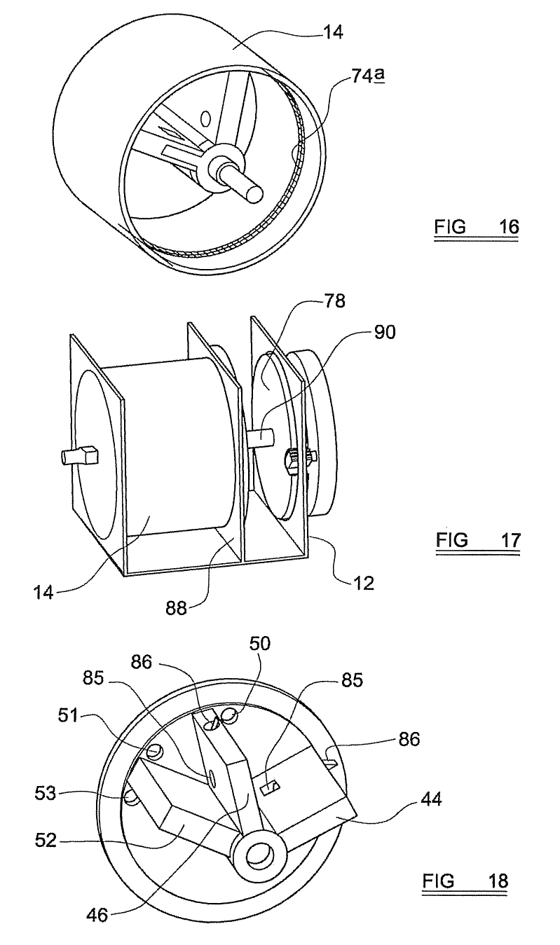

FIGS. 16 and 18 are schematic perspective views each showing part of the assembly of FIGS. 15 and 17, and

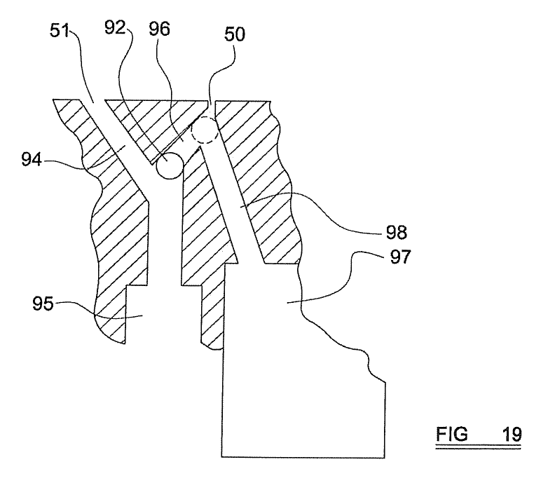

FIG. 19 is a schematic sectional view showing a valve arrangement which may be incorporated in a motor vehicle safety belt pretensioner arrangement embodying the invention.

Referring to FIGS. 1 and 2, a seat belt retractor 10 comprises a frame 12 in which is rotatably mounted a reel or bobbin 14 of cylindrical form to which, in known fashion, is secured one end of a seat belt (not shown) which is wound around the bobbin in manner known per se. A pretensioner actuator assembly 16, herein for convenience termed pre-tensioning motor 16, has respective rotary output member 18, 20 on opposite sides thereof, one, 18, of which is pneumatically powered, (as described below) and is coupled via a driving belt 22 with a pulley 24 mounted on an extension of the reel 14 on one side of the latter, said extension being in the form of a shaft projecting through a bearing provided in the frame 12. The pulley 24 is associated with a spring-biasing mechanism 26, for example utilising a spiral or clock-type spring (not shown) and which operates to tension the seat belt around the wearer in normal use and to rotate the reel to rewind the seat belt thereon when the wearer unbuckles the belt. The extension of the reel referred to is normally free to rotate within the pulley 24 but the pulley 24 can be coupled to said extension of the reel 14 for rotation therewith by a friction or other clutch arrangement, known per se, when the pulley 24 is rotated by the pneumatically powered output member 18 of the motor 16, whereby the reel is forced to rotate in a sense to tension the seat belt.

The output member 20 at the other side of the motor 16 is powered, by a pyrotechnic device, (as described below), and is connected with a rotary member 28 (FIG. 4) by a wire or metal strip 30. The rotary member 28 is co-axial with the reel 14 and is part of a further clutch arrangement, such as a ratchet clutch, a further part of which is fixed with respect to the reel 14, for example being fixed to a shaft of the reel 14 extending through a bearing in the retractor frame 12, whereby rotation of the pyrotechnic output member 20 of the motor 16 will cause the rotary member 28, with respect to which the reel 14 is normally free to rotate in either sense, to be entrained by the further clutch arrangement and thus to be effectively fixed with respect to the member 28, whereby the reel is forced to rotate in a sense tension the seat belt, (whether or not the pneumatic output member of the motor has already rotated the bobbin to some extent in the sense to tension the seatbelt). Suitable clutch mechanisms, for example ratchet or friction clutch mechanisms allowing pretensioning of the reel 14 by the output members 18, 20 in the manner described will be familiar to those in the art. Analogous clutch arrangements are referred to with reference to FIGS. 5 to 19 below in relation to further embodiments of the invention.

The present invention is primarily concerned with the configuration of the combined pneumatic and pyrotechnic motor 16 and the equivalent pretensioning motors in other embodiments described below. Thus, referring to FIGS. 3 and 4, the motor 16 comprises a block 40 formed with a working chamber in the form of a cylindrical bore or recess 42 in which are rotatable first and second rotary pistons or vanes 44 and 46, each rotatable about the central axis A of the cylindrical bore 42 and supported for such rotation by bearings in end walls of the block. In the arrangement shown in FIGS. 1 to 4, the block 40 comprises two similar parts, each providing half of the axial length of the cylindrical bore and a respective end wall, but other configurations are, of course, possible. As regards the mounting of the pistons, simply by way of example, one of the pistons, (e.g. piston 46), may have, at its ends, centered on said axis, respective axial extensions 48 in the form of cylindrical tubes or sleeves supported in said bearings in the end walls of the recess 42, whilst the other piston, (e.g. piston 44), may be fixed to or integral with a central shaft 47 extending rotatably through said cylindrical sleeves, which form bearings for shaft 47. On one side of the block 40, the respective axial extension takes the form of a shaft extending from the block and carrying the output member or wheel 20. A stop member 52 of sector shape extends radially inwardly from the peripheral wall of the cylinder 42 to engage substantially sealingly, by its inner end, the surface of, for example, the central portion of shaft 47 and the adjoining parts of sleeves 48. The stop member is also sealed with respect to the peripheral wall of the cylinder 42 and with respect to the opposing end walls of the recess 42. Accordingly, there is defined within the cylinder 42, between the vane 44 and the vane 46, a first expansible working chamber, and there is defined, between the member 52 and the vane 46 a second expansible chamber. It will be understood that the first and second working chambers are sealed off from each other and from the exterior apart from their connections with ports 50, 51 and 53 as described below.

The first expansible working chamber is connected with an inlet port 50 which lies adjacent the vane 46 in the normal un-activated position of the latter. The second expansible working chamber is connected with an inlet port 51 which lies adjacent the stop member 52. The space defined within the cylinder 42 between the vane 44 and stop member 52, on the side of vane 44 remote from inlet port 51, is connected with a port 53 which lies near the stop member 52 on the side of the member 52 remote from inlet 51. The piston 44 forms, with the cylinder 42 and the adjoining piston 46, the driving portion of a first pretensioner capable of rotating the output member (band wheel) 18 which is mounted on shaft 47. The second piston 46, forms, with the cylinder 42 and stop member 52, the driving portion of a second pretensioner capable of rotating the output member (wheel) 20 which is mounted on the shaft 48.

The inlet 51 is connected with a pyrotechnic gas generator (not shown), whilst the inlet 50 is connected with a source of pressurised gas (not shown) via an appropriate valve arrangement (not shown). The port 53 normally functions as a ventilation port or exhaust port but may be connected with a source of pressurised gas for return of the piston 44 to its normal position after activation of the first pretensioner, where an anticipated crash has not actually occurred and where the second pretensioner has not been activated, as explained below. For purposes of illustration, FIG. 3 shows the piston 44 displaced somewhat from its normal un-activated position in which it lies adjacent the piston 46 in the un-activated position of the latter shown in FIG. 3 but on the opposite side of the port 50 from the piston 46. It is envisaged that, in a vehicle fitted with the seatbelt pretensioner arrangement illustrated, the first pretensioner, driven by piston 44, will be activated by a pre-crash sensor in response to, for example, abnormal deceleration or in response to inertial forces applied to the vehicle. Triggering of this pre-crash sensor causes the valve connecting the inlet 50 with the pressurised gas source, (herein, for convenience, referred to as the pneumatic source), to open, causing rotation of the piston 44 and its shaft 47 in a clockwise direction as viewed in FIG. 3 away from the piston 46 as the first working chamber defined in the cylinder 42 between the pistons 46 and 44 expands under the pneumatic pressure, thereby rotating the output member 18 to pretension the seatbelt to a degree determined by the pneumatic pressure behind the piston 44. Normally the piston 44 would come to rest before the piston 44 had rotated as far as the port 53 and the stop member 52. If a crash is in fact avoided, so that the pyrotechnic gas generator connected with port 51 is not fired, the pretensioning applied by the first pretensioner can be relieved by return movement of the piston 44 in the anticlockwise sense as viewed in FIG. 3, which may be assisted by applying pressurised gas to the port 53 by appropriate operation of an associated valve mechanism (not shown). As previously noted, the port 53, during clockwise movement of the piston 44, acts as a vent for escape of the air contained in the chamber defined between the piston 44 and the stop member 52 on the clockwise side of the piston 44 as viewed in FIG. 3.

If, however, following the above-described activation and clockwise rotation of the piston 44 in the cylinder 42, the sensor which controls firing of the pyrotechnic gas generator is triggered, (for example by decelerational or inertial forces acting on the vehicle substantially in excess of those triggering the pre-crash sensor, such as forces arising from the early stages of an actual impact event), the pyrotechnic device is fired and accordingly the piston 46 is driven in an a clockwise direction as viewed in FIG. 3 by the pyrotechnic gas pressure, (normally an order of magnitude greater than the pneumatic pressure referred to), acting behind the piston 46, thereby rotating the wheel 20 and thus further tightening the seat belt about the wearer. During this clockwise movement of the piston 46, the gas pressure between the piston 46 and piston 44 may cause the piston 44 also to rotate further in a clock-wise direction as viewed in FIG. 3. Likewise, if the pre-crash sensor controlling the pneumatic source has, for some reason, not been triggered when the pyrotechnic device is fired, the anticlockwise rotation of the piston 46 will also push the piston 44 in a clockwise sense as viewed in FIG. 3.

It will be appreciated that, by virtue of the characteristics of the clutch arrangements connected with the first and second pretensioner pistons 44 and 46, as discussed above, the arrangement described potentially allows pretensioning rotation of the retractor reel through the rotational extent produced by a full stroke or displacement of the piston 44 from its un-activated position to a position engaging the stop 52, plus the rotational extent imparted to the reel by a full stroke or displacement of the pyrotechnic piston 46 from its unactivated position shown in FIG. 3 to its fully displaced position in which it lies against the piston 44, which in turn lies against the stop member 52.

The ports 50, 51 and 53, in the embodiments of the invention described, with reference to FIGS. 1 to 18 are formed in one end wall of the recess 42, but in some variants these ports could be formed in the circumferential wall of the cylinder.

The construction and operation of the pretensioner motor 16, as regards the cylindrical form of the recess 42 within which the pistons 44, 46 work; the rotational mounting of the pistons 44, 46; the location of the ports 50, 51 and 53 and the connections of these ports with pneumatic and pyrotechnic sources, is substantially the same in the embodiments of FIGS. 5 to 18 below as is described above in relation to FIGS. 1 to 4, except where differences are explicitly stated, and like references are used to denote like parts in the description relating to these embodiments.

In the embodiment of FIGS. 1 to 4, the shaft 47 extends on one side through the respective end wall of the block where the output pulley 18 is secured to the shaft, and, on the opposite side, one of the sleeves 48 is extended to form a hollow shaft projecting from the block, with the wheel 20 being secured to that hollow shaft.

Referring to FIGS. 5 to 9, these show an embodiment of the invention in which the pre-tensioning motor is incorporated within a hollow seat belt retractor reel or bobbin 14. In this arrangement, as best shown in FIG. 8, the cylindrical space 42 within which the motor pistons or vanes work is provided by the interior of a cylindrical drum 40a having an annular wall 41a coaxial with the reel, the drum 40a being received within the hollow reel or bobbin 14, and being fixed with respect to the frame 12 in which the reel 14 rotates.

In this embodiment the drum 40a has, extending from its end wall at one axial end of the drum, a cylindrical spigot 60 having respective passages extending therethrough parallel with the axis of the drum and leading to the ports 50,51 and 53 formed in that end wall of the drum 40a. An appropriate manifold (not shown) engages the end of this spigot 60 remote from the drum 40a and provides communication of these passages with the pneumatic and pyrotechnic gas sources and additionally holds the drum 40a against rotation relative to the retractor frame 12. The spigot 60 or a bearing sleeve 62 fitted thereon, acts as a journal supporting the reel 14 and its tread head 43 on one side of the frame 12 for rotation with respect the frame 12, in a bearing which is not shown. The spigot 60 also carries a collar in which is mounted a latch of a conventional retractor blocking mechanism co-operating with teeth formed in the retractor frame to provide the normal inertia blocking function of the seat belt arrangement.

In this embodiment, one of the pistons, piston 46, again has, at its ends, centered on the axis of cylinder 42, respective axial extensions in the form of cylindrical tubes or sleeves 48 supported in bearings in the end walls of the drum 40a, whilst the other piston is fixed to or integral with a central shaft, referenced 47a, extending rotatably through said cylindrical tubes or sleeves, which tubes or sleeves form bearings for the central shaft. In this embodiment the central shaft 47a has an axial through passage and on one side of the drum 40a the respective cylindrical tube or sleeve 48 is extended as hollow tubular shaft 48a (only an end part of which is shown in FIG. 9) and on that side the hollow central shaft 47a (only an end part of which is likewise shown in FIG. 9), is also extended coaxially within the shaft 48a, and projects from the free end of the shaft 48a. The shafts 47a, 48a extend sealingly through a central bore (not shown) in the end wall of the drum 40a remote from spigot 60 and, as shown in FIG. 9, carry at their free ends, within the reel 14, respective radially extending arms 62 and 64 which arms carry respective inertia latches 66 with leaf springs 70. These latches are capable of engaging with locking teeth 74 which extend in a circumferential track (only part of which track is shown in FIG. 9), around the internal surface of the reel 14 at the location of these arms 62 and 64. It will be understood that the piston shaft 47a may, for example, project beyond the arms 62, 64 into a central bore in the adjacent end of the reel 14, and which forms a bearing for these shafts, the reel 14, at that end, being in turn rotatably supported in the retractor frame 12. As shown, that end of the reel is connected with a conventional rewind spring mechanism. The arrangement of FIGS. 5 to 9 is similar as regards the configuration and mounting of the shafts extending from the piston similar to that of FIGS. 10 to 14 described below. Whilst, in FIG. 8, the cylinder 40a is shown as being spaced radially inwardly from the interior of the hollow reel 14, the drum may act as a plain journal supporting the reel 14 for rotation.

In the arrangement of FIGS. 10 to 14, the pretensioner motor again comprises a stationary cylindrical drum, referenced 40b (see FIG. 14), which is accommodated within a hollow retractor reel 14, the pretensioner motor again comprising first and second rotary pistons or vanes 44,46 configured similarly to those of the embodiments of FIGS. 1 to 4 and 5 to 9. Thus, in this embodiment, one of the pistons again has, at its ends, centered on the axis of cylinder 42, respective axial extensions 48 in the form of cylindrical tubes or sleeves supported in bearings in the end walls of the drum 40b, whilst the other piston is fixed to or integral with a central shaft 47b extending rotatably through said cylindrical tubes or sleeves, which form bearings for shaft 47b. In this embodiment, the central shaft 47b again has an axial through passage, and on one side of the drum 40b the respective outer cylindrical tube or sleeve is extended as hollow tubular shaft 48b and on that side the hollow central shaft 47b is also extended coaxially within the shaft 48b, and projects from the free end of the shaft 48b. The shafts 47b, 48b again extend sealingly through a central bore (not shown) in the end wall of the drum 40b.

In this embodiment, shaft 48b extends from one end of the retractor reel 14, through a manifold structure 76, to a tread head 78, and the inner hollow shaft 47b on the same side of the drum 40b likewise extends axially from the drum, within shaft 48b, through the manifold structure 76 to the tread head 78.

The end of the hollow shaft 48b within the tread head carries a disc 80 and the end of the shaft 47b projecting beyond the disc 80 carries a further disc 82 adjacent and parallel with disc 80. The discs 80, 82 carry respective inertial or the like latches or pawls 85 engageable with locking teeth 74a which extend in a circumferential track around the internal surface of a collar 81 formed integrally with the tread head and coaxial with the latter. Each of the last-mentioned latches or pawls forms, with said track of locking teeth 74a, a respective clutch arrangement whereby rotation of the respective hollow shaft 47b, 48b by its piston can impart consequent rotation to the tread head. In this embodiment, as shown in FIG. 14, the tread head is, in turn, connected with the end of the retractor reel 14 remote from the tread head by a torsion bar 84 which extends axially through the hollow shafts and thus through the drum 40b.

Referring to FIGS. 15 to 18, a further embodiment of the invention is shown in which the pretensioner motor again has a working cylinder provided within the hollow cylindrical retractor reel 14. In this embodiment, the working cylinder 42 of the pretensioner motor is provided by the hollow interior of the retractor reel 14 itself, which, of course, rotates in the retractor frame 12. Accordingly, the stop member 52, in this embodiment is not fixed to the reel but is fixed with respect to the retractor reel frame 12. By way of example, the stop member 52 may be fixed to a stationary end wall 88 of the working chamber, which the respective end of the retractor reel 14 engages sealingly whilst being rotatable with respect thereto. FIG. 15 shows inlets to the ports 50, 51 and 53 as being provided on the circumference of a solid cylindrical part of end wall 88. In this embodiment, the central shafts or extensions of the pistons or vanes need not extend from the cylinder 42, because the interior surface of the drum is provided with one or more circumferentially extending tracks of recesses forming ratchet “teeth” 74a for engagement with pawls 86 carried by the pistons themselves and which can be projected radially outwardly to engage such ratchet “teeth”. As shown, the pawls 86 may be a sealing sliding fit in respective radial passages in their respective pistons, such passages connecting at their inner ends with respective inlets 85 on the respective faces subject to gas pressure of the pistons 44, 46 whereby these pawls are arranged to be urged radially outwards from their respective pistons by gas pressure in the respective working chamber. To ensure sealing tightness, of course, successive ratchet teeth are in the form of spaced-apart recesses in the otherwise smooth, cylindrical, internal surface of the reel 14, each said recess being shorter in the circumferential direction than the radially outer ends of the vanes or pistons 44, 46. The pyrotechnic and pneumatic inlet ports in this case are, of course, provided in the stationary end wall 88. In this arrangement, the circumferential wall of the safety belt reel 14 may be connected, for example by an end wall integral with this circumferential wall at the axial end of the reel opposite the stationary wall 88, to an axially extending shaft which may, as illustrated in FIG. 17, take the form of a torsion bar 90 connected, in turn, with a tread head 78 rotatably mounted in the retractor frame, said axial shaft 90 passing through a central aperture in said stationary wall 88.

Referring to FIG. 19, a blocking or valve arrangement may be provided in order to minimise loss of pyrotechnically generated gas, with consequent loss of pressure, when the pyrotechnic device is activated. (Minimising such loss allows the use of a smaller capacity pyrotechnic device than would otherwise by necessary). The blocking or valve arrangement referred to effectively closes off the pneumatic inlet 50 into the motor chamber 42, at or close to that chamber, when the pyrotechnic device is fired. As shown schematically in FIG. 19, this blocking arrangement comprises a valve element 92, such as a steel ball, located in a passage 96 extending between a passage 94 connecting the inlet port 51 with the pyrotechnic gas generator 95 and a passage 98 extending from the pneumatic pressure source 97 to the pneumatic inlet port 50. The element 92 sits sealingly in the passage 96, which is of substantially constant cross-section through its length, and when the pyrotechnic device is fired, the pyrotechnic gas pressure forces the element 92 along the passage 96 from a normal position, (shown in solid line), remote from the passage 98 to a position, (shown in broken line), in which it is projected partially from the passage 96 and blocks off the passage 98 adjacent the inlet 50. The element 92 may be a slight interference fit in the bore 96 to ensure that it remains in its first position shown in solid lines in FIG. 19 until the pyrotechnic device is fired. It will be understood, of course, that any other valve arrangement operating to the same effect, under pyrotechnic gas pressure, may be used.

1-8. (canceled)

9. A pretensioner arrangement for a vehicle safety belt comprising:
a retractor reel mounted for rotation in a retractor frame; and
a pretensioner actuator assembly including a first pretensioner having a first output member having a normal position, the first output member being connected with the retractor reel by way of a first clutch arrangement, the actuator assembly including a second pretensioner having a second output member having a normal position, the second output member being connected with the retractor reel by way of a second clutch arrangement, the first and second clutch arrangements being such that the first output member can, via the first clutch arrangement, rotate the retractor reel by up to a predetermined extent without displacement of the second output member and the second clutch arrangement of the second output member can, if the second output member is energized, engage the retractor reel, via the second clutch arrangement, to apply torque to the retractor reel, from the beginning of displacement of the second output member from its normal position.

10. The pretensioner arrangement according to claim 9, wherein the first output member is a rotary output member coupled with or constituted by a first rotary piston mounted within a working cylinder having a first input for gas under pressure to drive the rotary piston, and hence the first output member, and wherein the second output member is a rotary output member coupled with or constituted by a second rotary piston mounted within a working cylinder having a second input for gas under pressure to drive the second rotary piston, and hence the second output member.

11. The pretensioner arrangement according to claim 10, wherein the first inlet is connected, via valve mechanism, with a reservoir of pressurised gas and the second inlet is connected with a pyrotechnic gas generator.

12. The pretensioner arrangement according to claim 10, wherein the first and second rotary pistons share a common working cylinder, and each of the first and second rotary pistons takes the form of a vane extending generally radially in the cylinder and in substantial sealing relationship with the peripheral surface of the cylinder; in sealing relationship with opposite ends of the cylinder and in sealing relationship with respect to, or integral with, a central structure in the cylinder, the pretensioner actuator assembly further including a radially extending fixed stop or wall in the cylinder extending from the peripheral wall of the cylinder to the central structure and in substantial sealing relationship with the peripheral surface of the cylinder; in sealing relationship with opposite ends of the cylinder and in sealing relationship with respect to the central structure.

13. The pretensioner arrangement according to claim 11, further comprising a valve arrangement operable to close off the first inlet, at or close to the cylinder, when the pyrotechnic device is fired, the valve arrangement including a valve element located in a connecting passage extending between a first gas passage extending from the pneumatic pressure source to the first inlet and a second gas passage connecting the pyrotechnic gas generator and the second input, the valve element being adapted to be propelled, by pyrotechnic gas pressure from the pyrotechnic gas generator, along the connecting passage from a normal position remote from the first passage to a position in which it is projected partially from the connecting passage to block off the first passage adjacent the first inlet.

14. The pretensioner arrangement according to claim 9, wherein the first and the second pretensioners are arranged to be triggered by respective sensors, with the sensor for the first pretensioner being triggered at a lower threshold of a sensed parameter than the pre-crash sensor for the second pretensioner.

15. The pretensioner arrangement according to claim 12, wherein the working chamber is provided by a hollow interior of the retractor reel and the first output member is constituted by the first rotary piston and carries at least one latch tooth or pawl which cooperates with teeth formed internally in the working cylinder to form the first clutch arrangement and the second output member is constituted by the second rotary piston (and carries at least one latch tooth or pawl which cooperates with teeth formed internally in the working cylinder to form the second clutch arrangement.

16. The pretensioner arrangement according to claim 12, wherein the retractor reel is hollow and wherein each of the first and second rotary pistons has a respective shaft fixed thereto, coaxial with the working chamber and extending from the working chamber and within the hollow retractor reel, and wherein the shaft fixed to the first piston carries a member within the reel which has a tooth or pawl which cooperates with teeth formed internally in the hollow retractor reel to form the first clutch arrangement and wherein the shaft fixed to the second piston carries a member within the reel which has a tooth or pawl which cooperates with teeth formed internally in the hollow retractor reel to form the second clutch arrangement.
